(19) United States
(12) Patent Application Publication
(10) Pub. No.: US 2024/0091856 A1
(43) Pub. Date: Mar. 21, 2024

(54) SEPARATION OF STAINLESS STEEL SLAG

(71) Applicant: MAGSORT OY, Helsinki (FI)

(72) Inventor: Niklas TÖRNKVIST, Helsinki (FI)

(21) Appl. No.: 18/254,574

(22) PCT Filed: Nov. 25, 2021
(86) PCT No.: PCT/FI2021/050809

§ 371 Date: May 25, 2023

(30) Foreign Application Priority Data
Nov. 26, 2020 (FI) 20206205

(51) Int. Cl. B22F 9/04; B03B 9/04; B03C 1/30; B22F 1/05

(52) U.S. Cl. CPC B22F 9/04; B03B 9/04; B03C 1/30; B22F 1/05; B03C 2201/20; B22F 2202/05; B22F 2301/35; B22F 2304/10; B22F 2998/10

(57) ABSTRACT

Described here is a method for recovering stainless steel from stainless steel slag, wherein the method comprises providing stainless steel slag, subjecting the stainless steel slag to dry milling followed by classifying the milled stainless steel slag to at least two fractions based on particle size characterised as small and middle fraction based on the particle size. The small and middle fractions are individually subjected to magnetic separation to separate a magnetic fraction from a non-magnetic fraction. The magnetic fractions are subjected to further separation to obtain particles with concentrated amount of stainless steel, which are subsequently recovered.

### FIELD OF THE INVENTION

The present invention relates to a method for separation stainless-steel from slag obtained from stainless-steel production. In particular, the invention relates to a method comprising dry milling of the stainless steel slag followed by separation of particles based on a combination of size and weight to obtain stainless steel from the milled slag.

### BACKGROUND OF THE INVENTION

Slag is one of the major by-products in steel and stainless-steel production. It is essential to find uses for all various by-products of industrial processes, including stainless-steel slag. Stainless-steel slag has found uses as filler material in various applications such as in cement substitutes, in concrete production and also in making slag phosphate fertilizers.

The slag that originates from stainless steel production, also called stainless-steel slag, still contains various amount of metallic stainless-steel. The metallic stainless-steel in the slag is valuable and there is a need to further develop economical methods for recovering it from the slag, especially on an industrial scale. The recovery of stainless-steel from the slag need to be efficient, i.e. needs to obtain sufficient amount of stainless-steel as well as economically worthwhile without the need of large investments in facilities.

There are also methods for recovering stainless-steel from slag, e.g. publication EP1805329 describe a method in which the slag is crushed under dry conditions followed by recovering stainless-steel using a sensor separator. The sensor separator measures attenuation of inductances of the crushed waste pieces. After the initial separation a follow-up separation using a magnetic separation is performed.

Publication EP 1312415 describe a method for recovering stainless steel from stainless steel slags, wherein the method comprises introducing water into a wet jigging apparatus wherein a slurry of comminuted stainless steel slag having a predetermined particle size and the material is segregated based on density.

Conventional wet milling plants that use wet jigging apparatus are generally expensive and require the use of water, which may constitute inconveniences in form of environmental aspects.

There is therefore a need for a more simple, flexible and scalable methods for recovering stainless steel from stainless steel slag.

### BRIEF DESCRIPTION OF THE INVENTION

An object of the present invention to provide a water-free method for recovering stainless-steel, which is simple and flexible to use depending on the slag. Provided is also method, which is scalable and feasible on industrial scale. The present invention thereby provides a by a method characterized by what is stated in the independent claim. The preferred embodiments of the invention are disclosed in the dependent claims.

The current invention thereby provides a method comprising the following steps:
(a) providing stainless steel slag,
(b) subjecting the stainless steel slag to dry milling to obtain milled stainless steel slag,
(c) classifying the milled stainless steel slag to at least two fractions based on particle size and the fractions are characterised as small and middle fraction based on the particle size, and optionally a third large fraction, which optionally is recycled back for further dry milling,
(d) subjecting the small and middle fractions individually to magnetic separation to separate a magnetic fraction from a non-magnetic fraction,
(e) subjecting the small and middle magnetic fractions individually to further separation to obtain particles with concentrated amount of stainless steel, and
(f) recovering the particles with concentrated amount of stainless steel.

An advantage of the present invention is that the process does not require the use of any external water. Therefore, there is no need for water treatment processes. The presented process is also stable and require less and smaller equipment, which means less operational and service maintenance. Although the needed constructions are smaller compared to conventional wet milling facilities, the capacity to treat slag is maintained or even increased.

### DETAILED DESCRIPTION OF THE INVENTION

The current invention describes a method for recovering stainless-steel from stainless-steel slag. The term “stainless-steel slag” here refers to any solid waste or by-product formed in the production of stainless-steel. The stainless-steel slag can typically contain up to 4 to 5 weight % metallic stainless-steel, which is a valuable product. The rest of the slag comprises various calcium, silica, iron and chromium oxides.

A typical stainless steel slag can have the following composition (in wt-%):

| | |
|---|---|
| SiO₂ | 48% |
| Fe₂O₃ | 4% |
| Cr₂O₃ | 4% |
| MnO | 5% |
| CaO | 23% |
| MgO | 10% |
| Al₂O₃ | 2% |
| SO₃ | 2%. |

The stainless-steel slag is first subjected to a dry milling to obtain milled stainless-steel slag. The dry milling here means that essentially no water or other liquid is added to the slag before the milling. The slag can contain a certain amount of moisture depending on the production of the stainless steel as well as the pretreatment of the slag. In one embodiment of the invention the slag which is subjected to the dry milling has a moisture content from 2 wt. % to 15 wt. %, preferably from 3 wt. % to 8 wt. %.

As used herein the term “milling” and “dry milling” refers to any suitable method in which the slag is milled or crushed, i.e. to produce smaller particle size of a solid material. Milling and crushing can be performed using any suitable method or equipment and the properties of equipment used in the milling is not of importance. Herein the terms “milling” and “crushing” are used to denote the same procedure and are synonyms with each other, unless otherwise denoted.

The dry milling of the stainless steel slag can be performed with any suitable method including but not limited to milling, grinding, using a vertical or horizontal shaft impact crusher, a rotor centrifugal crusher or any combination thereof. The dry milling of the current invention can be performed in one or more than one step. In one embodiment the dry crushing of the slag is performed in two stages, of which the first dry milling provides coarser particles, which are subjected to a second stage dry milling, which provides finer particle sizes. In one embodiment of the invention, the dry crushing is performed in more than two stages, in which each subsequent stage provides more finer particles compared to the previous stage. The milling can be performed in at least two stages, of which each can further constitute one or more individual milling steps.

In one embodiment the dry milling of the stainless-steel slag is performed in one or more stages using mills according to patent publication FI128329. The size and capacities of the mills or crushers used in the dry milling step depend on the amount of slag to be treated. The number of mills or crushers and/or milling stages can depend on the type of stainless steel slag and the wanted distribution of particles based on size. A person of ordinary skills in the art is capable of designing and choosing the mills and how many milling stages are required to obtain the desired particles with desired particle sizes for further processing.

The stainless-steel slag that has been milled in the dry milling step is then classified based on the size of the particles. The classification of the milled slag particles can be performed using any suitable method for sieving or screening the formed particles. The classification or separation based on particle size is done to obtain at least two fractions with different particle sizes. The two fractions can be characterised as small fraction and middle fraction. In one embodiment also a large fraction is separated, which can be recycled back to the dry milling stage.

In one embodiment the dry milling stage can also comprise intermediate classifications based on particle size, where particles with a particle size under a pre-determined particle size are subjected to further processing and the larger particles are subjected to further dry milling.

In one embodiment of the invention the classification based on particle size is performed such that more than two or more than three fractions are obtained. If more than two fractions are obtained, the obtained fractions can still be characterised into two main fractions, namely small fraction and middle fraction. As an example, the small fraction can contain more than one sub-fractions depending on the particle size.

In one embodiment the classification is performed such that particles with a particle size of about 5 mm or less are classified as small fraction. In another embodiment the small fraction is characterised as particles with a particle size of 10 mm or less. In one embodiment, particles with a particle size of 10 mm, 15 mm or 20 mm or larger are classified as large fraction. The large fraction can be reentered to the dry crushing step for further dry crushing.

In one embodiment the classification of the crushed slag is classified in five or six different fractions, such as the small fraction contain three or four subfractions, one to two middle fraction and one large fraction, which can be recirculated back to further dry milling. The classification can e.g. be performed such that the following fractions are obtained:
0-400 μm (small sub-fraction)
400 μm-1 mm (small sub-fraction)
1 mm-2 mm (small sub-fraction)
2 mm-5 mm (small sub fraction)
5 mm-10 mm (middle fraction)
>10 mm (large fraction).

It is to be understood that the above description of the various fractions and sub-fraction only serve as examples how to classify the crushed particles by to particle size. The number of specific fractions and the size-distribution of the particles in various sub-fraction is not important for carrying out the invention. The number of fractions and size-distribution of the particles within the fractions can be designed and planned based on the amount of slag and the capacities of the separation techniques chosen to carry out the invention.

After the classification of the milled particles based on particle size to obtain fractions based on particle size the fractions characterised as small and middle fraction are subjected to a magnetic separation. The fractions are subjected to the magnetic separation as individual fractions, i.e. the fractions with different particle size particles are not mixed before the subsequent separation steps. For the magnetic separation any suitable magnetic separation technique can be applied.

In one embodiment of the invention the magnetic separation is performed in two stages or more. The two stages of the magnetic separation can be performed by a first magnetic separation using a strong magnet followed by a second magnetic separation using a weak magnet. The weak magnetic separation can also be performed before the strong magnetic separation. A combination of two strong magnetic separations can also be applied. The strong magnetic separation can be performed using a rare earth magnet, an electromagnet or other type of strong magnet.

Stainless-steel slag contains austenitic, ferritic and martensitic stainless-steel, which are magnetic at least to some degree. The ferritic and martensitic stainless steel are clearly magnetic and can easily be separated using magnetism. Austenitic stainless steel can also be magnetic, although not as strong as ferritic and martensitic stainless steel. Particles containing magnetic stainless-steel can be separated from particles showing no magnetism. The non-magnetic particles are separated and discharged from the process. The non-magnetic particles find uses as e.g. fillers in concrete or cement substitute. The separation of magnetic particles from non-magnetic particles reduces the amounts of particles to be further processed with up to 40%, such as up to 50% or preferably up to 55%.

The magnetic separation is beneficial to reduce the mass or amount of slag particles to be subjected to the further separation. Especially is a densitometric table is used for the final separation of stainless steel particles it is useful to reduce the mass of the particles. The densitometric tables are limited on the basis of their capacity. It has been found that using a combination of dry milling, classification to certain particle sizes, followed by first magnetic separation and then specific or further separation, such as densitometric separation it is possible to recover stainless steel from slag with high capacity despite the limited capacity of the densitometric separation.

The fractions containing magnetic particles are collected and subjected to further separation. It is noteworthy that the fractions are still kept separate, and the further separation is also performed on the individual fraction obtained in the classification based on particle size. The further separation is any separation that is able to separate particles based on the concentration (amount of) stainless steel in the particle. The particles with a higher amount of stainless-steel are collected and the stainless-steel is recovered from the separated portion of the particles.

In one embodiment of the invention the further separation is performed using densitometric separation. A densitometric separation is any separation, which separation is based on variations in the density of the particles. Typical densitometric separations are a densitometric table and a windshifter separation techniques. In one embodiment of the invention the further separation is performed using a densitometric table. A densitometric table can separate particles based on their weight, heavier particles are separated from lighter particles over a gradient.

In one embodiment of the invention the further separation is performed using windshifter separation technique. A combination of densitometric table and windshifter separation can also be used for the further densitometric separation.

In one embodiment of the invention the small fraction or fraction characterised as small fraction is subjected to a further separation using a densitometric table. The middle fraction or fractions characterised as middle fraction are subjected to a further separation using a densitometric table or a windshifter separator. The densitometric table separation is typically used for particles with a particle size of smaller than 2 mm, 5 mm or 10 mm. A windshifter separation is typically suitable for separation of particles with a particle size larger than 5 mm or 10 mm.

The further separation using a densitometric table can be performed with any suitable equipment or design. An example of a densitometric table is presented in patent publication EP 280127 B, which describe a separator consisting of a vibrating pneumodensitometric table ensuring a homogeneous fluidizing action by the perforated table (1), the upper part of which is consisting of a finely perforated metal plate while the lower part (3) is consisting of synthetic fabric. There is also a wide range of other commercially available systems and equipment suitable for use in the further separation.

Windshifter separators are also commercially available and any suitable design or equipment can be used for the further separation. In addition to or in to combination with a windshifter separator also a so called Advanced Dry Recovery (ADR) separator, as described e.g. in EP 1606056, can be used.

In one embodiment of the invention the fraction(s) characterised as small fraction contain particles with a particle diameter of 5 mm or less; the fraction(s) characterised as middle fraction contain particles with a particle diameter of more than 5 mm and less than 10 mm and the particles with a particle diameter of 10 mm or more is characterised as large fraction. Alternatively, in one embodiment of the invention the fraction(s) characterised as small fraction contain particles with a particle diameter of 1 mm or less; the fraction(s) characterised as middle fraction contain particles with a particle diameter of more than 1 mm and less than 5 mm and the particles with a particle diameter of 5 mm or more is characterised as large fraction. Any combination of the two alternatives is also possible.

It has surprisingly been found that a significant portion of the stainless-steel from stainless steel slag can be recovered using a combination of classification of the milled particles to specific fractions followed by a further separation, where the further separation can be a separation based on weight such as using densitometric table and/or windshifter. It has been found that stainless steel can be recovered at least as sufficient using a dry milling compared to a wet process.

In a further embodiment the invention also relates to a method for upgrading stainless steel slag, wherein the method comprises:
(a) providing stainless steel slag,
(b) subjecting the stainless steel slag to dry milling to obtain milled stainless steel slag,
(c) classifying the milled stainless steel slag to at least two fractions based on particle size and the fractions obtained are characterised as small fraction and large fraction based on particle size,
(d1) subjecting the large fraction to at least one second dry milling step to obtain a second set of milled stainless steel slag, and subjecting the second set of milled stainless steel slag to a separation to separate particles containing stainless steel from particles not containing stainless steel
or
(d2) subjecting the large fraction to a separation to separate particles containing stainless steel from particles not containing stainless steel and collecting the particles containing stainless steel for possible further processes.

The separation in step (d1) or (d2) can be performed using a densitometric separation selected from a densitometric table, a windshifter and any combination thereof. The further processing of the large fraction can in addition comprise classification based on particle size and/or further separation based on magnetic separation. The particle size of the particles of the large fraction can more than 5 mm or more than 10 mm.

It will be obvious to a person skilled in the art that, as the technology advances, the inventive concept can be implemented in various ways. The invention and its embodiments are not limited to the examples described above but may vary within the scope of the claims.

1. A method for recovering stainless steel from stainless steel slag, wherein the method comprises the following steps:
(a) providing stainless steel slag,
(b) subjecting the stainless steel slag to dry milling to obtain milled stainless steel slag,
(c) classifying the milled stainless steel slag to at least two fractions based on particle size and the fractions are characterised as small and middle fraction based on the particle size, and optionally a third large fraction, which optionally is recycled back for further dry milling,
(d) subjecting the small and middle fractions individually to magnetic separation to separate a magnetic fraction from a non-magnetic fraction,
(e) subjecting the small and middle magnetic fractions individually to further separation to obtain particles with concentrated amount of stainless steel, and
(f) recovering the particles with concentrated amount of stainless steel.

2. The method according to claim 1, wherein step (b) of dry milling the stainless steel slag is performed in two stages, a first coarse dry milling following by a second fine dry milling.

3. The method according to claim 1, wherein step (d) of magnetic separation is performed in two stages, a first magnetic separation using a strong magnet followed by a second magnetic separation using a weak magnet.

4. The method according to claim 1, wherein the classification of the milled stainless-steel slag in step (c) is performed such that more than two fractions are obtained and the obtained fractions are characterised as small and middle fractions based on the particle size.

5. The method according to claim 1, wherein the further separation of step (e) is performed using a densitometric separation such as a densitometric table or a windshifter separation, or an advanced dry recovery separation or any combination thereof.

6. The method according to claim 5, wherein the fraction(s) characterised as small fraction(s) is/are further separated in step (e) as individual fractions using a densitometric table.

7. The method according to claim 5, wherein the fraction(s) characterised as middle fraction(s) is/are further separated in step (e) as individual fractions using a densitometric table, a windshifter separation or a combination thereof.

8. The method according to claim 1, wherein the method step (c) comprises the step of classifying the milled stain less steel slag to a large fraction, which is recycled for further milling.

9. The method according to claim 1, wherein the step (b) of dry milling the stainless steel slag further comprise intermediate classification of the milled stainless steel slag to separate particles for further separation and particles for further dry milling.

10. The method according to claim 1, wherein the fraction(s) characterised as small fraction contain particles with a particle diameter of 5 mm or less; the fraction(s) characterised as middle fraction contain particles with a particle diameter of more than 5 mm and less than 10 mm and the particles with a particle diameter of 10 mm or more is characterised as large fraction.

11. A method for upgrading stainless steel slag, wherein the method comprises:
(a) providing stainless steel slag,
(b) subjecting the stainless steel slag to dry milling to obtain milled stainless steel slag,
(c) classifying the milled stainless steel slag to at least two fractions based on particle size and the fractions obtained are characterised as small fraction and large fraction based on particle size,
(d1) subjecting the large fraction to at least one second dry milling step to obtain a second set of milled stainless steel slag, and subjecting the second set of milled stainless steel slag to a separation to separate particles containing stainless steel from particles not containing stainless steel,
or
(d2) subjecting the large fraction to a separation to separate particles containing stainless steel from particles not containing stainless steel and collecting the particles containing stainless steel for possible further processes.

12. The method according to claim 11, wherein the separation in step (d1) or (d2) is performed using a densitometric separation selected from a densitometric table, a windshifter separation and any combination thereof.

13. The method according to claim 11, wherein the further processing of the large fraction in addition comprises further classification based on particle size and/or further separations based on magnetic separation.

14. The method according to claim 11, wherein the particle size of the particles of the large fraction is more than 5 mm or more than 10 mm.
